(19) United States
(12) Patent Application Publication
(10) Pub. No.: US 2015/0124601 A1
(43) Pub. Date: May 7, 2015

(54) METHOD AND APPARATUS FOR NETWORK TRAFFIC OFFLOADING

(71) Applicant: Nokia Corporation, Espoo (FI)

(72) Inventors: Zexian Li, Espoo (FI); Eng Hwee Ong, Singapore (SG)

(73) Assignee: Nokia Corporation, Espoo (FI)

(21) Appl. No.: 14/400,705

(22) PCT Filed: Apr. 23, 2013
(86) PCT No.: PCT/FI2013/050449

§ 371 Date: Nov. 12, 2014

Related U.S. Application Data
(60) Provisional application No. 61/647,782, filed on May 16, 2012.

(51) Int. Cl. H04W 36/22; H04W 28/02

(52) U.S. Cl. CPC H04W 36/22; H04W 28/0268
USPC 370/230

(57) ABSTRACT

A method, apparatus and computer program product are provided for managing network traffic offloading. In the context of a method, a method is provided that includes determining, based at least in part on a QoS (Quality of Service) mapping scheme, whether a data flow should be offloaded from a first access point to a second access point. The method may further include, if it is determined that the offload should be performed, causing the data flow to be offloaded to the second access point according to the QoS mapping scheme and causing a perceived QoS of the data flow to be monitored. The method may further include, in an instance in which the perceived QoS does not satisfy a predetermined desired QoS threshold, causing a remedial action to be performed.

### TECHNOLOGICAL FIELD

An example embodiment of the present invention relates generally to techniques for accessing a network and, more particularly, to a method and apparatus for managing network traffic offloading.

### BACKGROUND

The amount of wireless traffic is predicted by some to increase by a factor of 1000 from 2010 to 2020 and cellular operators are increasingly seeking solutions to cope with this increasing volume. The rapidly increasing data traffic volume over cellular networks has brought increased attention to unlicensed bands, such as the ISM (industrial, scientific and medical) band from licensed band cellular operators. In 3GPP (3rd Generation Partnership Project) there is ongoing discussion about the potential of using unlicensed spectrum to benefit cellular networks. For example, integrating WLAN (wireless local area networks) into cellular networks could allow cellular network data to be offloaded to unlicensed bands to relieve network strain.

However, offloading data traffic to unlicensed bands without resulting in noticeable performance loss, or even with a performance gain, can be problematic. More specifically, it can be challenging to maintain the QoS (quality of service) levels that cellular customers are accustomed to when offloading network data to WLAN due to operational differences between WLAN and cellular systems.

### BRIEF SUMMARY

A method, apparatus and computer program product are therefore provided according to an example embodiment of the present invention for managing network traffic offloading. In this regard, the method, apparatus, and computer program product may determine whether a data flow should be offloaded from a first access point to a second access point. Following offloading, the method, apparatus, and computer program product may monitor a perceived QoS of the data flow and perform a remedial action if the QoS does not satisfy a predetermined threshold. The various embodiments thus provide efficient and effective solutions to managing network traffic offloading in a way that may maintain QoS during and after the offloading.

In one embodiment, a method is provided that includes determining, based at least in part on a QoS (Quality of Service) mapping scheme, whether a data flow should be offloaded from a first access point to a second access point; and, in an instance in which it is determined that the offload should be performed: causing the data flow to be offloaded to the second access point according to the QoS mapping scheme, causing a perceived QoS of the data flow to be monitored, and, in an instance in which the perceived QoS does not satisfy a predetermined desired QoS threshold, causing a remedial action to be performed.

In a further embodiment, an apparatus is provided that includes at least one processor and at least one memory including program code instructions, the at least one memory and the program code instructions being configured to, with the processor, direct the apparatus to at least determine, based at least in part on a QoS (Quality of Service) mapping scheme, whether a data flow should be offloaded from a first access point to a second access point; and, in an instance in which it is determined that the offload should be performed: cause the data flow to be offloaded to the second access point according to the QoS mapping scheme, cause a perceived QoS of the data flow to be monitored, and, in an instance in which the perceived QoS does not satisfy a predetermined desired QoS threshold, cause a remedial action to be performed.

In an even further embodiment, a computer program product is provided that includes a non-transitory computer readable medium storing program code portions therein. The computer program code instructions are configured to, upon execution, direct an apparatus to at least determine, based at least in part on a QoS (Quality of Service) mapping scheme, whether a data flow should be offloaded from a first access point to a second access point; and, in an instance in which it is determined that the offload should be performed: cause the data flow to be offloaded to the second access point according to the QoS mapping scheme, cause a perceived QoS of the data flow to be monitored, and, in an instance in which the perceived QoS does not satisfy a predetermined desired QoS threshold, cause a remedial action to be performed.

In a still further embodiment, an apparatus is provided that includes means for determining, based at least in part on a QoS (Quality of Service) mapping scheme, whether a data flow should be offloaded from a first access point to a second access point; and means for, in an instance in which it is determined that the offload should be performed: causing the data flow to be offloaded to the second access point according to the QoS mapping scheme, causing a perceived QoS of the data flow to be monitored, and, in an instance in which the perceived QoS does not satisfy a predetermined desired QoS threshold, causing a remedial action to be performed.

### BRIEF DESCRIPTION OF THE DRAWINGS

Having thus described example embodiments of the invention in general terms, reference will now be made to the accompanying drawings, which are not necessarily drawn to scale, and wherein:

FIG. 1 is a schematic representation of a system that may support example embodiments of the present invention;

FIG. 2 is a block diagram of an electronic device that may be configured to implement example embodiments of the present invention;

FIG. 3 is a block diagram of an apparatus that may be embodied by or associated with an electronic device, and may be configured to implement example embodiments of the present invention; and

FIG. 4 is a flowchart illustrating the operations performed in accordance with embodiment of the present invention.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received, processed and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a physical storage medium (e.g., volatile or non-volatile memory device), can be differentiated from a “computer-readable transmission medium,” which refers to an electromagnetic signal.

As described below, a method, apparatus and computer program product are provided for managing network traffic offloading. In this regard, the method, apparatus and computer program product of an example embodiment may permit network traffic to effectively be offloaded from a first access point to a second access point. The first access point may be associated with a first network, such as, for example, a cellular network, and the second access point may be associated with a second network, such as, for example, a WLAN (Wireless Local Area Network). Thus, the methods, apparatuses and computer program products of these embodiments may allow efficient and effective offloading of network traffic from a first access point to a second access point, for example, in order to relieve strain on the first network caused by excessive traffic volume, while minimizing QoS (Quality of Service) losses.

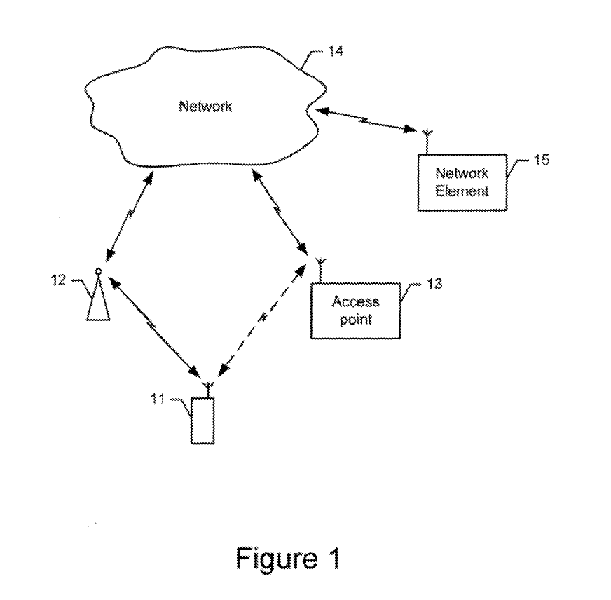

FIG. 1 illustrates a block diagram of a system that may benefit from network traffic offloading. While FIG. 1 illustrates one example of a configuration of a system for implementing this functionality, numerous other configurations may be used to implement embodiments of the present invention. With reference to FIG. 1, however, the system may include a user device 11 connected to a common network 14, such as the internet, via a first access point 12. The system may also include a second access point 13 that the user device may connect to so as to access the common network 14. Either or both of the first 12 and second 13 access points may have also respective first and second networks associated therewith (not shown). The system may also include a network device, such as network element 15, which is also connected to the common network 14. Network element 15 may also, or alternatively, be connected to either or both of the networks that may be associated with the first 12 or second 13 access points (not shown).

User device 11 may be any device that is configured to communicate over a network. For example, user device 11 may be a mobile terminal, such as a mobile telephone, PDA, pager, laptop computer, tablet computer, data card, Universal Serial Bus (USB) dongle, or any of numerous other hand held or portable communication devices, computation devices, content generation devices, content consumption devices, or combinations thereof.

The first 12 and second 13 access points may be wired or wireless access points which may provide connected user devices, such as user device 11, access to a common network 14. For example, one or both of access points 12 and 13 may be a base station, an access node, or any equivalent, such as a Node B, an evolved Node B (eNB), a relay node, or other type of access point. Access points 12 or 13 may also be an access point configured to provide access to a local-area network, such as a WLAN. Thus, access points 12 or 13 may be access points configured to operate in accordance with a WIFI standard, such as IEEE 802.11. Access points 12 and/or 13 may access the common network 14 via wired means, such as via fiber optic, coaxial, or Ethernet cable, digital subscriber line (DSL), or by connecting with a wireless network, such as a Long Term Evolution (LTE) network, an LTE-Advanced (LTE-A) network, a Global Systems for Mobile communications (GSM) network, a Code Division Multiple Access (CDMA) network, e.g., a Wideband CDMA (WCDMA) network, a CDMA2000 network or the like, a General Packet Radio Service (GPRS) network or other type of network. Access points 12 and/or 13 may be operated in licensed spectrum band and/or unlicensed spectrum band.

Access points 12 and 13 may provide user device 11 with access to network 14 using different means and/or via different associated intervening networks, such that offloading network traffic from the first access point to the second access point provides relief to the network associated with the first access point. In an example embodiment, access point 12 may be a base station, such as an eNB, configured to provide user device 11 with access to network 14 via an associated LTE network, and access point 13 is an access point configured in accordance with a WIFI standard to provide user device 11 with access to network 14 via an associated WLAN network.

Network element 15 is any type of network-accessible device. For example, network element 15 may be a Packet Data Gateway. Network element 15 may, for example, communicate with access points 12 and/or 13, and user device 11 over one or more networks, such as the common network 14, and/or respective other networks that may be associated with access points 12 and/or 13. Alternatively, network element 15 may communicate directly with, or otherwise be directly associated with, either of access points 12 or 13.

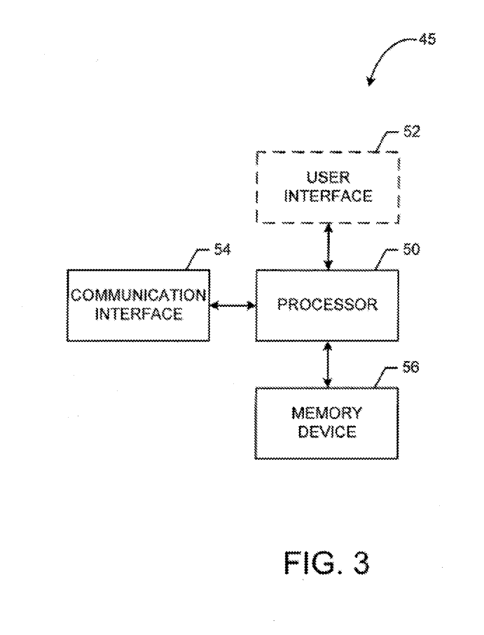

Any or all of user device 11, access point 12, access point 13, and network element 15 may include or be associated with an apparatus 45, such as shown in FIG. 3, configured in accordance with embodiments of the present invention, as described below.

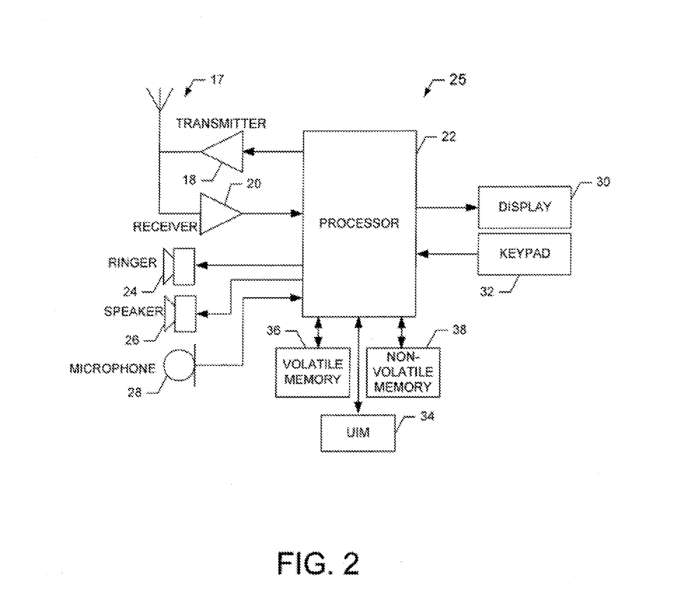

In one embodiment, user device 11 may be embodied by a mobile terminal. In this regard, a block diagram of a mobile terminal 25 that would benefit from embodiments of the present invention is illustrated in FIG. 2. It should be understood, however, that the mobile terminal 25 as illustrated and hereinafter described is merely illustrative of one type of user device that may benefit from embodiments of the present invention and, therefore, should not be taken to limit the scope of embodiments of the present invention. As such, although numerous types of mobile terminals, such as PDAs, mobile telephones, pagers, mobile televisions, gaming devices, laptop computers, cameras, tablet computers, touch surfaces, wearable devices, video recorders, audio/video players, radios, electronic books, positioning devices (e.g., global positioning system (GPS) devices), or any combination of the aforementioned, may readily employ embodiments of the present invention, other user devices including fixed (non-mobile) electronic devices may also employ some example embodiments.

The mobile terminal 25 may include an antenna 17 (or multiple antennas) in operable communication with a transmitter 18 and a receiver 20. The mobile terminal 25 may further include an apparatus, such as a processor 22 or other processing device (e.g., processor 50 of the apparatus of FIG. 3), which controls the provision of signals to and the receipt of signals from the transmitter 18 and receiver 20, respectively. The signals may include signaling information in accordance with the air interface standard of the applicable cellular system, and also user speech, received data and/or user generated data. In this regard, the mobile terminal 25 is capable of operating with one or more air interface standards, communication protocols, modulation types, and access types. By way of illustration, the mobile terminal 25 is capable of operating in accordance with wireless communication mechanisms. For example, mobile terminal 25 may be capable of communicating in a wireless local area network (WLAN) or other communication networks, for example in accordance with one or more of the IEEE 802.11 family of standards, such as 802.11a, b, g, or n. As an alternative (or additionally), the mobile terminal 25 may be capable of operating in accordance with any of a number of first, second, third and/or fourth-generation cellular communication protocols or the like. For example, the mobile terminal 25 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with 3.9 G wireless communication protocol such as evolved UMTS Terrestrial Radio Access Network (E-UTRAN), with fourth-generation (4G) wireless communication protocols (e.g., Long Term Evolution (LTE) or LTE-Advanced (LTE-A) or the like.

In some embodiments, the processor 22 may include circuitry desirable for implementing audio and logic functions of the mobile terminal 25. For example, the processor 22 may be comprised of a digital signal processor device, a microprocessor device, and various analog to digital converters, digital to analog converters, and other support circuits. Control and signal processing functions of the mobile terminal 25 are allocated between these devices according to their respective capabilities. The processor 22 thus may also include the functionality to convolutionally encode and interleave message and data prior to modulation and transmission. The processor 22 may additionally include an internal voice coder, and may include an internal data modem. Further, the processor 22 may include functionality to operate one or more software programs, which may be stored in memory. For example, the processor 22 may be capable of operating a connectivity program, such as a conventional Web browser. The connectivity program may then allow the mobile terminal 25 to transmit and receive Web content, such as location-based content and/or other web page content, according to a Wireless Application Protocol (WAP), Hypertext Transfer Protocol (HTTP) and/or the like, for example.

The mobile terminal 25 may also comprise a user interface including an output device such as a conventional earphone or speaker 26, a ringer 24, a microphone 28, a display 30, and a user input interface, all of which are coupled to the processor 22. The user input interface, which allows the mobile terminal 25 to receive data, may include any of a number of devices allowing the mobile terminal 25 to receive data, such as a keypad 32, a touch screen display (display 30 providing an example of such a touch screen display) or other input device. In embodiments including the keypad 32, the keypad 32 may include the conventional numeric (0-9) and related keys (#, *), and other hard and soft keys used for operating the mobile terminal 25. Alternatively or additionally, the keypad 32 may include a conventional QWERTY keypad arrangement. The keypad 32 may also include various soft keys with associated functions. In addition, or alternatively, the mobile terminal 25 may include an interface device such as a joystick or other user input interface. Some embodiments employing a touch screen display, as described further below, may omit the keypad 32 and any or all of the speaker 26, ringer 24, and microphone 28 entirely. The mobile terminal 25 further includes a battery, such as a vibrating battery pack, for powering various circuits that are required to operate the mobile terminal 25, as well as optionally providing mechanical vibration as a detectable output.

The mobile terminal 25 may further include a user identity module (UIM) 34. The UIM 34 is typically a memory device having a processor built in. The UIM 34 may include, for example, a subscriber identity module (SIM), a universal integrated circuit card (UICC), a universal subscriber identity module (USIM), a removable user identity module (R-UIM), etc. The UIM 34 typically stores information elements related to a mobile subscriber. In addition to the UIM 34, the mobile terminal 25 may be equipped with memory. For example, the mobile terminal 25 may include volatile memory 36, such as volatile Random Access Memory (RAM) including a cache area for the temporary storage of data. The mobile terminal 15 may also include other non-volatile memory 38, which may be embedded and/or may be removable. The memories may store any of a number of pieces of information, and data, used by the mobile terminal 15 to implement the functions of the mobile terminal 25.

Example embodiments of the invention will now be described with reference to FIG. 3, in which certain elements of an apparatus 45 for managing network traffic offloading are depicted. In order to manage network traffic offloading, the apparatus 45 of FIG. 3 may be employed, for example, in conjunction with any or all of user device 11, access point 12, access point 13, and network element 15 of FIG. 1. Thus, functionality of apparatus 45 discussed below may, according to some embodiments, be carried out in one of the aforementioned devices. However, according to other embodiments, the functionality of apparatus 45 discussed below may be distributed across multiple devices, each comprising a respective apparatus 45.

It should also be noted that while FIG. 3 illustrates one example of a configuration of an apparatus 45 for managing network traffic offloading, numerous other configurations may also be used to implement embodiments of the present invention. As such, in some embodiments, although devices or elements are shown as being in communication with each other, hereinafter such devices or elements should be considered to be capable of being embodied within a same device or element and thus, devices or elements shown in communication should be understood to alternatively be portions of the same device or element.

Referring now to FIG. 3, the apparatus 45 for managing network traffic offloading may include or otherwise be in communication with a processor 50, a communication interface 54, and a memory device 56. As described below and as indicated by the dashed lines in FIG. 3, the apparatus 45 may also optionally include a user interface 52 in some embodiments, such as embodiments in which the apparatus 45 is embodied by user device 11. In some embodiments, the processor 50 (and/or co-processors or any other processing circuitry assisting or otherwise associated with the processor 50) may be in communication with the memory device 56 via a bus for passing information among components of the apparatus 45. The memory device 56 may include, for example, one or more volatile and/or non-volatile memories. In other words, for example, the memory device 56 may be an electronic storage device (e.g., a computer readable storage medium) comprising gates configured to store data (e.g., bits) that may be retrievable by a machine (e.g., a computing device like the processor 50). In the embodiment in which the apparatus 45 is embodied as a mobile terminal 25, the memory device 56 may be embodied by the memory 36, 38. The memory device 56 may be configured to store information, data, content, applications, instructions, or the like, for enabling the apparatus to carry out various functions in accordance with an example embodiment of the present invention. For example, the memory device 56 could be configured to buffer input data for processing by the processor 50. Additionally or alternatively, the memory device 56 could be configured to store instructions for execution by the processor 50.

The apparatus 45 may, in some embodiments, be embodied by or associated with a user terminal (e.g., mobile terminal 25) or a fixed communication device (e.g., network element 15, access point, 12 and/or access point 13) or computing device configured to employ an example embodiment of the present invention. However, in some embodiments, the apparatus 45 may be embodied as a chip or chip set. In other words, the apparatus 45 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 45 may therefore, in some cases, be configured to implement an embodiment of the present invention on a single chip or as a single “system on a chip.” As such, in some cases, a chip or chipset may constitute means for performing one or more operations for providing the functionalities described herein.

The processor 50 may be embodied in a number of different ways. For example, the processor 50 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 50 may include one or more processing cores configured to perform independently. A multi-core processor may enable multiprocessing within a single physical package. Additionally or alternatively, the processor 50 may include one or more processors configured in tandem via the bus to enable independent execution of instructions, pipelining and/or multithreading. In the embodiment in which the apparatus 45 is embodied as a mobile terminal 25, the processor 50 may be embodied by the processor 22.

In an example embodiment, the processor 50 may be configured to execute instructions stored in the memory device 56 or otherwise accessible to the processor 50. Alternatively or additionally, the processor 50 may be configured to execute hard coded functionality. As such, whether configured by hardware or software methods, or by a combination thereof, the processor 50 may represent an entity (e.g., physically embodied in circuitry) capable of performing operations according to an embodiment of the present invention while configured accordingly. Thus, for example, when the processor 50 is embodied as an ASIC, FPGA or the like, the processor 50 may be specifically configured hardware for conducting the operations described herein. Alternatively, as another example, when the processor 50 is embodied as an executor of software instructions, the instructions may specifically configure the processor 50 to perform the algorithms and/or operations described herein when the instructions are executed. However, in some cases, the processor 50 may be a processor of a specific device (e.g., a mobile terminal or network entity) configured to employ an embodiment of the present invention by further configuration of the processor 50 by instructions for performing the algorithms and/or operations described herein. The processor 50 may include, among other things, a clock, an arithmetic logic unit (ALU) and logic gates configured to support operation of the processor 50.

Meanwhile, the communication interface 54 may be any means such as a device or circuitry embodied in either hardware or a combination of hardware and software that is configured to receive and/or transmit data from/to a network, such as network 14, or any other networks associated with access points 12 and/or 13, and/or any other device or module in communication with the apparatus 45. In this regard, the communication interface 54 may include, for example, an antenna (or multiple antennas) and supporting hardware and/or software for enabling communications with a wireless communication network. Additionally or alternatively, the communication interface 54 may include the circuitry for interacting with the antenna(s) to cause transmission of signals via the antenna(s) or to handle receipt of signals received via the antenna(s). In some environments, the communication interface 54 may alternatively or also support wired communication. As such, for example, the communication interface 54 may include a communication modem and/or other hardware/software for supporting communication via cable, digital subscriber line (DSL), universal serial bus (USB) or other mechanisms. In the embodiment in which the apparatus 45 is embodied as a mobile terminal 25, the communication interface 54 may be embodied by the antenna 16, transmitter 18, receiver 20 or the like.

In some embodiments, such as instances in which the apparatus 45 is embodied by user device 11, the apparatus 45 may include a user interface 52 that may, in turn, be in communication with the processor 50 to receive an indication of a user input and/or to cause provision of an audible, visual, mechanical or other output to the user. As such, the user interface 52 may include, for example, a keyboard, a mouse, a joystick, a display, a touch screen(s), touch areas, soft keys, a microphone, a speaker, or other input/output mechanisms. Alternatively or additionally, the processor 50 may comprise user interface circuitry configured to control at least some functions of one or more user interface elements such as, for example, a speaker, ringer, microphone, display, and/or the like. The processor 50 and/or user interface circuitry comprising the processor 50 may be configured to control one or more functions of one or more user interface elements through computer program instructions (e.g., software and/or firmware) stored on a memory accessible to the processor 50 (e.g., memory device 56, and/or the like). In other embodiments, however, such as in instances in which the apparatus 45 is embodied by access point 12, access point 13, or network element 15, the apparatus 45 may not include a user interface 52.

As noted in the Background, the amount of wireless traffic is predicted to increase by several orders of magnitude between 2010 and 2020 and operators need solutions to cope with the rapidly increasing volume. There is ongoing discussion in 3GPP (3rd Generation Partnership Project) about integrating WLAN into cellular networks to help deal with cellular network strain. One idea is to implement a network traffic offloading scheme to offload cellular network traffic onto WLANs. However, managing network traffic offloading from cellular to WLAN can be complex, due to the very different QoS implementations relied on by WIFI and cellular standards, such as LTE.

For example, in LTE there are clearly defined QoS classes with different parameters. Each bearer (user data) path in LTE is assigned a set of QoS criteria. In the case when a user may have services requiring different QoS criteria, additional bearer paths may be added. LTE identifies a set of QoS criteria with QoS Class Identities (QCIs). Standardized QCI characteristics are listed in Table 1.

TABLE 1
Standardized QCI characteristics
for LTE (3GPP TS 23.203 Rel-10)

| | | | | Packet | |
|---|---|---|---|---|---|
| | Re- | | Packet | Error | |
| | source | Pri- | Delay | Loss | |
| | Type | ority | Budget | Rate | Example Services |
| 1 | GBR | 2 | 100 ms | 10⁻² | Conversational Voice |
| 2 | (Guaran- | 4 | 150 ms | 10⁻³ | Conversational Video (Live |
| | teed | | | | Streaming) |
| 3 | Bit | 3 | 50 ms | 10⁻³ | Real Time Gaming |
| 4 | Rate) | 5 | 300 ms | 10⁻⁶ | Non-Conversational Video |
| | | | | | (Buffered Streaming) |
| 5 | Non- | 1 | 100 ms | 10⁻⁶ | IMS Signalling |
| 6 | GBR | 6 | 300 ms | 10⁻⁶ | Video (Buffered Streaming) |
| | | | | | TCP-based (e.g., www, e- |
| | | | | | mail, chat, ftp, p2p file shar- |
| | | | | | ing, progressive video, etc.) |
| 7 | | 7 | 100 ms | 10⁻³ | Voice, |
| | | | | | Video (Live Streaming) |
| | | | | | Interactive Gaming |
| 8 | | 8 | 300 ms | 10⁻⁶ | Video (Buffered Streaming) |
| 9 | | 9 | | | TCP-based (e.g., www, e- |
| | | | | | mail, chat, ftp, p2p file shar- |
| | | | | | ing, progressive video, etc.) |

On the other hand, in 802.11e the traffic is assigned a priority level prior to transmission. These are termed User Priority (UP) levels and there are eight in total. Having done this, the transmitter then prioritizes all the data by assigning it one of the four Access Categories (AC). Table 9-1 from IEEE 802.11-2007 is shown below.

TABLE 2
UP to AC mappings for IEEE 802.11

| | UP | | | |
|---|---|---|---|---|
| | (Same as | | | |
| | 802.1D user) | 802.1D | | Designation |
| Priority | priority) | designation | AC | (informative) |
| 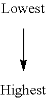 | 1 2 0 3 4 5 6 7 | BK — BE EE CL VI VO NC | AC_BK AC_BK AC_BE AC_BE AC_VI AC_VI AC_VO AC_VO | Background Background Best Effort Best Effort Video Video Voice Voice |

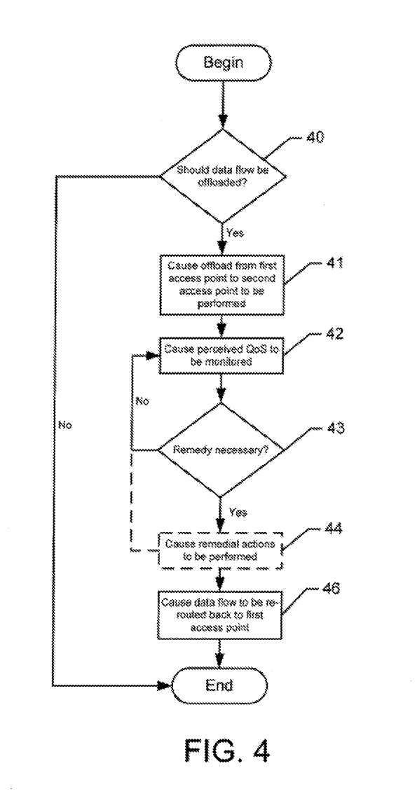

Thus, when offloading cellular network traffic, e.g., LTE network traffic, to another network, e.g., a WLAN, an important issue is how to guarantee or maintain similar QoS support following the offload procedure. More specifically, determining how to map the QoS parameters used in the connection to the first access point to the QoS parameters used in a connection to the second access point, deciding what traffic to offload, and maintaining the required QoS in the connection to the second access point following the offloading procedure are all issues that may be addressed in order to effectively and reliably offload network traffic from a first access point to a second access point. Functionality of apparatus 45 related to these three areas will be discussed in turn, with reference to the operations depicted in FIG. 4.

Before proceeding, however, it will be understood that although the various embodiments of the present invention will be discussed as operating on data flows, which may include one or more packets, all of the apparatuses, methods, and computer program products according to embodiments of the present invention may alternatively or additionally operate on individual packets. Thus, “data flow” as defined hereinafter may refer to both a data flow comprised of a plurality of packets as well as one or more individual packets.

QoS Mapping and Determining What Types of Traffic to Offload

Referring now to FIG. 4, the operations for managing network traffic offloading are depicted. In this regard and as described below, the operations of FIG. 4 may be performed by an apparatus 45, such as shown in FIG. 3, embodied by or otherwise associated with any or all of user device 11, access point 12, access point 13, or network element 15. In this regard, the apparatus 45 may include means, such as the processor 50, the communication interface 54 or the like, for determining whether a data flow should be offloaded from a first access point to a second access point. See operation 40. In this regard, according to an example embodiment, a QoS mapping scheme may be used to determine what types of traffic to offload. Thus, the process of determining whether a given data flow should be offloaded may involve two steps: first, determining whether the flow is of a type that should be considered for offloading, and second, determining whether the second access point can provide sufficient QoS to justify the offload. The first step will now be discussed.

An example QoS mapping scheme according to one embodiment, in which the first access point 12 is configured to provide user device 11 with access to network 14 via a cellular network, such as an LTE network, and the second access point 13 is configured to provide user device 11 with access to network 14 via a WLAN network, such as a WLAN in accordance with IEEE 802.11 WIFI standard, is shown in Table 3, below.

TABLE 3
Example QoS Mapping between cellular network (e.g., LTE) and WLAN

| | | | | Packet | | |
|---|---|---|---|---|---|---|
| | | | Packet | Error | | WLAN AC |
| | Resource | | Delay | Loss | | (Access |
| QCI | Type | Priority | Budget | Rate | Example Services | Category) |
| 1 | GBR | 2 | 100 ms | 10⁻² | Conversational Voice | AC_VO |
| 2 | | 4 | 150 ms | 10⁻³ | Conversational Video (Live | AC_VI |
| | | | | | Streaming) | |
| 3 | | 3 | 50 ms | 10⁻³ | Real Time Gaming | AC_VO |
| 4 | | 5 | 300 ms | 10⁻⁶ | Non-Conversational Video | AC_VI |
| | | | | | (Buffered Streaming) | |
| 5 | Non- | 1 | 100 ms | 10⁻⁶ | IMS Signalling | AC_VO |
| 6 | GBR | 6 | 300 ms | 10⁻⁶ | Video (Buffered Streaming) | AC_BE |
| | | | | | TCP-based (e.g., www, e-mail, | |
| | | | | | chat, ftp, p2p file sharing, | |
| | | | | | progressive video, etc.) | |
| 7 | | 7 | 100 ms | 10⁻³ | Voice, | AC_VI |
| | | | | | Video (Live Streaming) | |
| | | | | | Interactive Gaming | |
| 8 | | 8 | 300 ms | 10⁻⁶ | Video (Buffered Streaming) | AC_BE |
| 9 | | 9 | | | TCP-based (e.g., www, e-mail, | |
| | | | | | chat, ftp, p2p file | |
| | | | | | sharing, progressive video, etc.) | |

Thus this example QoS mapping scheme allows the evolved packet system (EPS) bearers QoS to receive similar treatment when offloaded to Wi-Fi. Many other QoS mapping schemes are possible as well. For example, the priority of data flows can be sequentially mapped according to their respective packet delay budget. As another example, and if more flexibility is preferred, a dynamic QoS mapping scheme can be employed. Dynamic mapping may, for example, entail filtering out flows for which QoS requirements cannot be met, and/or upgrading the priority of flows which QoS requirements can be met. For example, if the packet delay budget for IMS (IP Multimedia Subsystem) signaling with priority 1 cannot be met by the second access point 13, which communicates with network 14 with a higher delay than the first access point 12, the IMS flow may be filtered out from offloading consideration and/or the priority of another flow whose delay requirements can be met by the second access point 13 may be upgraded. According to another embodiment, only certain types of traffic may be offloaded. For example, only Non-GBR or only GBR may be offloaded. In this case, it may be possible to have more fine mapping resolution. For example, according to an embodiment in which access point 12 is associated with a cellular network and access point 13 is associated with a WLAN network, instead of mapping the four WLAN ACs (access categories) across both GBR and non-GBR traffic, the four WLAN ACs may, for example, be mapped to GBR or Non-GBR independently. In other words, the four WLAN AC may be mapped only within the Non-GBR traffic class or only within the GBR traffic class.

Thus, the apparatus 45 may include means, such as the processor 50, the communication interface 54 or the like, for applying a mapping scheme, such as those discussed above, to a data flow and for determining, based on the mapping scheme, whether the data flow is a type that should be considered for offloading. The determination may take into account, for example, one or more properties of the data flow, such as, for example, its QoS class identifier, Resource Type, Priority, Packet Delay Budget, Packet Error Loss Rate, or WLAN Access Category.

Determining Whether to Offload a Particular Data Flow

According to a further embodiment, apparatus 45 may include means, such as the processor 50, the communication interface 54 or the like, for determining whether a data flow should be offloaded from a first access point to a second access point. See operation 40. As discussed above, this includes two determinations. The first is determining, based on a QoS profile, whether the data flow is of a type that should be considered for offloading. The second, which will now be discussed, is determining, in general, whether offloading the data flow to the second access point is likely to result in an unsatisfactory drop in QoS levels.

Thus, according to a first example embodiment, apparatus 45 may determine whether to offload a particular data flow based on the available capacity of the second access point. For example apparatus 45 may determine, such as via the processor 50, the communication interface 54 or the like, a traffic profile for the second access point. The traffic profile may comprise, for example, the packet size and arrival rate, e.g., packets/second, or average data rate. The traffic profile can be determined based on estimation or direct measurement of the utilization of a channel associated with the second access point. In this way, the traffic profile can be used to estimate the available capacity in the second access point. According to an example embodiment, if the load of the second access point is below a predetermined saturation point (i.e. if the available capacity is above a predetermined threshold), it may be determined the packet delay and packet loss would be of an acceptable range to support delay-sensitive services. Thus, if the load is below the saturation point, it may be determined that a data flow associated with a delay-sensitive service should be offloaded.

The available capacity of a WLAN access point (AP) may be computed from the estimated channel utilization as follows:

$${C}_{available} = {CU}_{max} - {CU}_{total} , \\ {CU}_{total} = {\sum }_{k ∈ flows} {CU}_{k} . \qquad ( 1 )$$

where CUₜₒₜₐₗ is the total channel utilization of k flows in a WLAN AP, CUₘₐₓ is the threshold which defines the maximum usable capacity of a WLAN AP, and C_{available} is the available capacity expressed in terms of channel utilization. Note that these metrics vary from 0 to 1 representing 0 to 100%. The channel utilization of each (and new) flow for the basic access scheme may be estimated as follows:

$${CU}_{k} = {λ}_{k} \cdot {T}_{s , k} , \\ \overline{{T}_{s , k}} = DIFS + \overline{{T}_{BO}} + 2 {T}_{PHY} + {T}_{DATA , k} + SIFS + {T}_{ACK} + 2 δ , \\ \overline{{T}_{BO}} = \frac{{CW}_{min}}{2} \cdot {T}_{SLOT} \qquad ( 2 )$$

where λₖ, T̅_̅{̅s̅,̅k̅}̅, T_{DATA,k} are the arrival rate, the average successful frame transmission time, and the data frame transmission time of the k-th flow, respectively. T̅_̅{̅B̅O̅}̅ is the average backoff time, T_{PHY} is the time required to transmit the PLCP preamble and header, T_{ACK} is the ACK frame transmission time. T_{SLOT}, CWₘᵢₙ, DIFS, SIFS are defined in the 802.11 standard. The same approach may be extended to consider optional RTS/CTS handshaking mechanism.

Alternatively, the CUₜₒₜₐₗ^{meas}, may be measured by the WLAN AP as follows:

$${CU}_{total}^{meas} = \frac{\sum busy \_ period}{{T}_{observation}} \qquad ( 3 )$$

where busy period includes time when a client of the WLAN AP is transmitting or receiving, and the channel is indicated as busy due to either clear channel assessment (CCA) or network allocation vector (NAV). T_{observation} is the observation period in ms.

In this way, a new flow may be offloaded from the first access point 12 associated with a first cellular network, such as an LTE network, to the second access 13 point associated with a second network, such as a WLAN, if channel utilization of the new flow CU_{new}<C_{available}. Further if CUₘₐₓ<1, then the QoS requirement of the LTE bearer can be met in WLAN with a high probability as the medium will be in the non-saturation state.

According to a second example embodiment, apparatus 45 may determine whether to offload a particular data flow based on a QoS measurement of the second access point. For example, apparatus 45 may determine, such as via the processor 50, the communication interface 54 or the like, a measurement of, for example, packet delay or packet loss and, based on the measurement, determine whether to offload the flow to the second access point. For example, if the measured packets delay in the second access point 12 is about 50 ms before the flow is offloaded, and if the measured delay can meet the latency requirement of the flow to be offloaded, then the flow can be offloaded to the second access point. Otherwise, according to another embodiment, another flow with a more relaxed delay requirement may be offloaded instead.

One method to estimate QoS parameters such as packet delay and packet loss in a WLAN AP is to perform one-step forecasting by using exponentially weighted moving average (EWMA) as follows:

Yₜ′=αYₜ+(1−α)Yₜ₋₁′ (4)

where Yₜ′ is the current forecasted EWMA of a QoS parameter, Yₜ is the current measured value of a QoS parameter, and Yₜ₋₁′ is the previous forecasted EWMA. α is the “forgetting” or smoothing factor which varies between 0 and 1. The forgetting factor determines the proportion of history information and current measurement used in the current forecast. E.g., α→0 implies the forecast is heavily weighted by history information while α→1 implies that the forecast is heavily weighted by current measurement.

Upon deriving the QoS estimation of packet delay and packet loss, for example, apparatus 45 may then use these estimates as a basis to determine whether or not a particular flow, such as an LTE flow, may be offloaded to the second access point, such as a WLAN AP, without much QoS degradation. For example, suppose there are three LTE flows with delay requirements of 50, 100, and 150 ms, respectively. Further suppose that the WLAN AP has a forecasted packet delay of 80 ms. In this case, apparatus 45 may determine that the LTE flow with 50 ms delay requirement cannot be offloaded, whereas the LTE flows with 100 and 150 ms delay requirements may be offloaded. On the other hand, apparatus 45 may also determine that only the LTE flow with delay requirement of 150 ms may be offloaded as it would bring about the least probability of QoS degradation.

According to another example embodiment, apparatus 45 may combine the use of both the first and second example embodiments described above to result in a more deterministic evaluation of the offloading decision. Thus, considering the same scenario as above, apparatus 45 may, after determining that the WLAN AP can only support the LTE flows with 100 and 150 ms delay requirements, proceed to determine additional channel utilization information which may be computed from equations (1)-(3), above. Thus, apparatus 45 may determine, after evaluating equations (1) and (2), above, that CU_{new}<C_{available} for both LTE flows with 100 and 150 ms delay requirements. Thus, apparatus 45 may determine not only whether the WLAN can meet the delay requirements of both of the flows, but has also whether both of the flows can be offloaded to the WLAN AP without causing QoS degradation because the WLAN AP will still be operating in the non-saturation state after accepting any one of these two flows. Note that this may only ensure that the WLAN AP is able to accept the new LTE flow without causing QoS degradation to the new and its existing connections. However, a QoS verification step, as discussed later, is still beneficial to ensure that QoS of the offloaded LTE flow can be maintained for its entire service duration.

According to a third example embodiment, apparatus 45 may determine whether to offload a particular data flow based on the results of a “try and test” operation. For example apparatus 45 may cause, such as via the processor 50, the communication interface 54 or the like, “dummy” packets with the same traffic characteristics and QoS parameters as the particular flow to be sent to network 14 via the second access point and measure the resulted QoS. One simple way is to duplicate the packets of the particular flow and cause the duplicates to be transmitted offloaded to the second access point. After causing the dummy flow to be offloaded, apparatus 45 can cause the second access point 13 to check the offered QoS level associated with the flow (e.g., similarly to the QoS verification procedure discussed below). If the offered QoS is at a similar or better level and the QoS of other offloaded traffic flows still meet their requirements as well, the particular data flow can be offloaded to the second access point 13.

In addition to the procedures discussed above, other alternative procedures are possible, as well as combinations of the discussed procedures and other possible procedures.

Apparatus 45 may also include means, such as the processor 50, the communication interface 54 or the like, for causing the data flow to be offloaded from the first access point 12 to the second access point 13, in an instance in which it is determined that the data flow should be offloaded to the second access point 13. Thus, apparatus 45 may cause the data flow to be transmitted to the second access point 13 instead of the first access point 12. In addition, apparatus 45 may also include means, such as the processor 50, the communication interface 54 or the like, for causing the data flow to be assigned a type, such as a WLAN AC, in accordance with a mapping scheme, such as one of those discussed above.

QoS Verification and Maintenance

According to a further embodiment, apparatus 45 may include means, such as the processor 50, the communication interface 54 or the like, for, after causing the data flow to be offloaded to the second access point 13, ensuring that the second access point 13 is able to maintain the desired QoS requirements for the offloaded data flow for the duration of the associated service. Thus, apparatus 45 may cause, for example, the QoS parameters associated with the second access point to be monitored. See operation 42 of FIG. 4. For example, according to one embodiment, apparatus 45 may cause the second access point to invoke periodic measurements of the QoS parameters and provide a forecasted QoS parameter value to apparatus 45. The forecasted parameter value may be calculated using EWMA as in equation (4), as described above. Apparatus 45 may also cause a record of the QoS parameter values to be maintained, such as in memory device 56.

If apparatus 45 determines, based on the received forecasted QoS parameter value, that the QoS requirements of the offloaded data flow can no longer be met, an alarm trigger may be signaled, indicating that a remedy is necessary. See operation 43 of FIG. 4. The alarm may be determined, for example, as follows:

$$Alarm = \{ \begin{matrix}0 , & max ( {Y}_{t , AP}^{′} , {Y}_{t , k}^{′} ) < {Thres}_{delay} \\ 1 , & max ( {Y}_{t , AP}^{′} , {Y}_{t , k}^{′} ) \geq {Thres}_{delay}\end{matrix} \qquad ( 5 )$$

where Y_{t,AP}′ is the current forecasted EWMA of a QoS parameter of the WLAN AP, Y_{t,k}′ is the current forecasted EWMA of a QoS parameter of k-th flow, and Thres_{delay} is the delay requirement of the offloaded data flow.

When an alarm is triggered, i.e., when it is determined that a remedy is necessary, apparatus 45 may cause certain actions to be taken. For example, according to one embodiment, apparatus 45 may simply cause the offloaded flow to be re-routed back to the first access point. See operation 46. This scheme is advantageous in its simplicity, as it ensures that the offloaded flow will be subjected to no or, at least, minimal QoS degradation by the second access point 13, and the second access point 13 does not need to be configured to adapt to the needs of the offloaded flow.

According to another example embodiment, apparatus 45 may cause remedial actions to be performed, instead of simply causing the offloaded data flow to be re-routed. See operation 44 of FIG. 4. Thus, apparatus 45 may cause, such as via the processor 50, the communication interface 54 or the like, the second access point to adaptively maintain the desired QoS threshold by modifying one or more parameters. For example, apparatus 45 may cause the second access point 13 to modify one or more enhanced distributed channel access (EDCA) parameters.

Thus, according to an example embodiment in which the second access point 13 is a WLAN AP, apparatus 45 may cause WLAN access point 13 to utilize prioritization techniques known from the 802.11e standard to adapt the EDCA parameters according to the prevailing perceived QoS of the offloaded flow. For example, the EDCA parameter set contains the following parameters which could be adjusted in order to prioritize the offloaded flows: Minimum/Maximum contention window size CWₘᵢₙ/CWₘₐₓ; Arbitration Inter-frame Space Number (AIFSN); and TXOP limit.

An AC with a smaller CWmin and AIFSN corresponds to higher priority and has a better chance to access the wireless medium earlier, while a longer TXOP limit enables the AC to seize the wireless medium for a longer period of time. Thus, the WLAN AP may be caused to, according to an example embodiment: (i) increase the CWₘᵢₙ; (ii) increase the AIFSN; and/or (iii) decrease the TXOP limit, for non-offloaded flows in the AC of the affected offloaded flow. The WLAN AP may, for example, be caused to broadcast the new EDCA parameter set element to all of its clients associated with non-offloaded flows. The EDCA parameter set may, for example, be updated to modify the EDCA parameters of the AC in which the offloaded flow is assigned. In this way, the offloaded flows may be prioritized and their perceived QoS may improve subsequently. Moreover, the value of the delay requirement Thres_{delay} in equation (5), above, may, for example, be lowered to compensate for the adaptation time. Lowering the delay threshold discourages new flows from being offloaded, ensuring the QoS requirements of existing flows can be met even if the adaptation time is long. An advantage of this scheme is that offloaded flows may continue to remain offloaded if necessary, such as, for example, when a network associated with the first access point 12 does not have sufficient capacity, or during the time when the first access point 12 is allocating radio resources for an impending data flow.

As shown in FIG. 4, the above two methods discussed above can be used in combination. Thus, according to an example embodiment, remedial actions can be attempted before resorting to re-routing the offloaded data flow back to the first access point. Thus, for example, remedial actions may be attempted a certain number of times before falling back to re-routing or, if it is determined that remedial actions were ineffective, the data flow may be re-routed after attempting remedial actions just once. According to another example, remedial actions may be skipped if delay thresholds are exceeded by a certain margin.

As described above, FIG. 4 illustrates a flowchart of an apparatus 45, method, and computer program product according to example embodiments of the invention. It will be understood that each block of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory device 56 of an apparatus 45 employing an embodiment of the present invention and executed by a processor 50 of the apparatus 45. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or enhanced. Furthermore, in some embodiments, additional optional operations may be included. Modifications, additions, or enhancements to the operations above may be performed in any order and in any combination.

The method, apparatus 45 and computer program product described above provide many advantages. For example the method, apparatus 45 and computer program products may provide an efficient and effective scheme for maintaining similar QoS for data flows offloaded from a first network, such as an LTE network, to a second network, such as a WLAN. The method, apparatus 45 and computer program products may also provide for dynamic offloading and flow switching that is enabled with link layer measurement feedback from WLAN to an LTE network. In other words, the WLAN may report measurements such as the available capacity and QoS estimations to the LTE eNB, and the eNB can thus make the decision about whether to offload a flow to the WLAN. The feedback information can also be used for dynamic flow switching in which different packets from a single flow are transmitted over different radios. The method, apparatus 45 and computer program products may also provide for transparent perceived QoS/QoE from an end-user perspective. That is, the end-user may be unaware of the offloading and flow switching operations taking place in accordance with embodiments of the invention. The method, apparatus 45 and computer program products may also provide many benefits to network operators, who can utilize the dynamic offloading provided by the embodiments to lower their capital expenditures while maintaining similar user experience.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

Thus, in summary, example embodiments of the present invention may provide the following:

(1) A method comprising: determining, based at least in part on a QoS (Quality of Service) mapping scheme, whether a data flow (such as one or more individual packets) should be offloaded from a first access point to a second access point; and, in an instance in which it is determined that the offload should be performed: causing the data flow to be offloaded to the second access point according to the QoS mapping scheme, causing a perceived QoS of the data flow to be monitored, and, in an instance in which the perceived QoS does not satisfy a predetermined desired QoS threshold, causing a remedial action to be performed.

The aforementioned mapping scheme may be a mapping scheme in accordance with Table 3; a sequential priority mapping according to packet delay budget; a dynamic mapping scheme; or a GBR/Non-GBR (guaranteed bitrate/non-guaranteed bitrate) only scheme.

Determining whether the offload from the first network to the second network should be performed may be further based on: a traffic profile; a QoS measurement; or a QoS measurement resulting from causing dummy packets with traffic characteristics that are the same as the data flow to be transmitted to the second access point, and causing the QoS of the transmitted dummy packets to be measured.

The remedial action may include causing the data flow to be transferred back to the first access point or causing the second access point to adaptively maintain the desired QoS threshold by modifying one or more parameters.

(2) An apparatus comprising at least one processor and at least one memory including program code instructions, the at least one memory and the program code instructions being configured to, with the processor, direct the apparatus to at least determine, based at least in part on a QoS (Quality of Service) mapping scheme, whether a data flow should be offloaded from a first access point to a second access point; and, in an instance in which it is determined that the offload should be performed: cause the data flow to be offloaded to the second access point according to the QoS mapping scheme, cause a perceived QoS of the data flow to be monitored, and, in an instance in which the perceived QoS does not satisfy a predetermined desired QoS threshold, cause a remedial action to be performed.

The aforementioned mapping scheme may be a mapping scheme in accordance with Table 3; a sequential priority mapping according to packet delay budget; a dynamic mapping scheme; or a GBR/Non-GBR (guaranteed bitrate/non-guaranteed bitrate) only scheme.

The apparatus may be caused to determine whether the offload from the first network to the second network should be performed further based on: a traffic profile; a QoS measurement; or a QoS measurement resulting from causing dummy packets with traffic characteristics that are the same as the data flow to be transmitted to the second access point, and causing the QoS of the transmitted dummy packets to be measured.

The remedial action may include causing the data flow to be transferred back to the first access point or causing the second access point to adaptively maintain the desired QoS threshold by modifying one or more parameters.

(3) A computer program product comprising a non-transitory computer readable medium storing program code portions therein, the computer program code instructions being configured to, upon execution, direct an apparatus to at least determine, based at least in part on a QoS (Quality of Service) mapping scheme, whether a data flow should be offloaded from a first access point to a second access point; and, in an instance in which it is determined that the offload should be performed: cause the data flow to be offloaded to the second access point according to the QoS mapping scheme, cause a perceived QoS of the data flow to be monitored, and, in an instance in which the perceived QoS does not satisfy a predetermined desired QoS threshold, cause a remedial action to be performed.

The aforementioned mapping scheme may be a mapping scheme in accordance with Table 3; a sequential priority mapping according to packet delay budget; a dynamic mapping scheme; or a GBR/Non-GBR (guaranteed bitrate/non-guaranteed bitrate) only scheme.

The program code portions may also be configured to, upon execution, cause the apparatus to determine whether the offload from the first network to the second network should be performed further based on: a traffic profile; a QoS measurement; or a QoS measurement resulting from causing dummy packets with traffic characteristics that are the same as the data flow to be transmitted to the second access point, and causing the QoS of the transmitted dummy packets to be measured.

The remedial action may include causing the data flow to be transferred back to the first access point or causing the second access point to adaptively maintain the desired QoS threshold by modifying one or more parameters.

(4) An apparatus comprising: means for determining, based at least in part on a QoS (Quality of Service) mapping scheme, whether a data flow should be offloaded from a first access point to a second access point; and means for, in an instance in which it is determined that the offload should be performed: causing the data flow to be offloaded to the second access point according to the QoS mapping scheme, causing a perceived QoS of the data flow to be monitored, and, in an instance in which the perceived QoS does not satisfy a predetermined desired QoS threshold, causing a remedial action to be performed.

The aforementioned mapping scheme may be a mapping scheme in accordance with Table 3; a sequential priority mapping according to packet delay budget; a dynamic mapping scheme; or a GBR/Non-GBR (guaranteed bitrate/non-guaranteed bitrate) only scheme.

The means for determining whether the offload from the first network to the second network should be performed may be further configured to make the determination based on: a traffic profile; a QoS measurement; or a QoS measurement resulting from causing dummy packets with traffic characteristics that are the same as the data flow to be transmitted to the second access point, and causing the QoS of the transmitted dummy packets to be measured.

The remedial action may include causing the data flow to be transferred back to the first access point or causing the second access point to adaptively maintain the desired QoS threshold by modifying one or more parameters.

The (1) method, (2) apparatus, and (3) computer program product described above may, for example, be deployed in a system in which the first access point comprises a base station associated with a cellular network, such as an LTE network, and the second access point comprises a wireless access point associated with a WLAN.

1-33. (canceled)

34. A method comprising:
determining, based at least in part on a QoS (Quality of Service) mapping scheme, whether a data flow should be offloaded from a first access point to a second access point; and,
in an instance in which it is determined that the offload should be performed:
causing the data flow to be offloaded to the second access point according to the QoS mapping scheme, causing a perceived QoS of the data flow to be monitored, and,
in an instance in which the perceived QoS does not satisfy a predetermined desired QoS threshold:
causing a remedial action to be performed.

35. The method of claim 34, wherein the mapping scheme comprises a mapping scheme in accordance with Table 3.

36. The method of claim 34, wherein the mapping scheme comprises a sequential priority mapping according to packet delay budget.

37. The method of claim 34, wherein the mapping scheme comprises a dynamic mapping scheme.

38. The method of claim 34, wherein determining whether the offload from the first network to the second network should be performed is further based at least in part on a QoS measurement resulting from causing dummy packets with traffic characteristics that are the same as the data flow to be transmitted to the second access point, the method further comprising causing the QoS of the transmitted dummy packets to be measured.

39. The method of claim 34, wherein the first access point comprises a base station associated with an LTE (long term evolution) network and the second access point comprises a wireless access point associated with a WLAN (wireless local area network).

40. An apparatus comprising at least one processor and at least one memory including program code instructions, the at least one memory and the program code instructions being configured to, with the processor, direct the apparatus to at least:
determine, based at least in part on a QoS (Quality of Service) mapping scheme, whether a data flow (such as one or more individual packets) should be offloaded from a first access point to a second access point; and,
in an instance in which it is determined that the offload should be performed:
cause the data flow to be offloaded to the second access point according to the QoS mapping scheme, causing a perceived QoS of the data flow to be monitored, and,
in an instance in which the perceived QoS does not satisfy a predetermined desired QoS threshold:
cause a remedial action to be performed.

41. The apparatus of claim 40, wherein the mapping scheme comprises a mapping scheme in accordance with Table 3.

42. The apparatus of claim 40, wherein the mapping scheme comprises a sequential priority mapping according to packet delay budget.

43. The apparatus of claim 40, wherein the mapping scheme comprises a dynamic mapping scheme.

44. The apparatus of claim 40, wherein the mapping scheme comprises a GBR/Non-GBR (guaranteed bitrate/non-guaranteed bitrate) only scheme.

45. The apparatus of claim 40, wherein the apparatus is directed to determine whether the offload from the first network to the second network should be performed further based at least in part on a traffic profile.

46. The apparatus of claim 40, wherein the apparatus is directed to determine whether the offload from the first network to the second network should be performed further based at least in part on a QoS measurement.

47. The apparatus of claim 40, wherein the apparatus is directed to determine whether the offload from the first network to the second network should be performed further based at least in part on a QoS measurement resulting from causing dummy packets with traffic characteristics that are the same as the data flow to be transmitted to the second access point, the apparatus being further directed to cause the QoS of the transmitted dummy packets to be measured.

48. The apparatus of claim 40, wherein the remedial action comprises causing the data flow to be transferred back to the first access point.

49. The apparatus of claim 40, wherein the remedial action comprises causing the second access point to adaptively maintain the desired QoS threshold by modifying one or more parameters.

50. The apparatus of claim 40, wherein the first access point comprises a base station associated with an LTE (long term evolution) network and the second access point comprises a wireless access point associated with a WLAN (wireless local area network).

51. A computer program product comprising a non-transitory computer readable medium storing program code portions therein, the computer program code instructions being configured to, upon execution, direct an apparatus to at least:
determine, based at least in part on a QoS (Quality of Service) mapping scheme, whether a data flow (such as one or more individual packets) should be offloaded from a first access point to a second access point; and,
in an instance in which it is determined that the offload should be performed:
cause the data flow to be offloaded to the second access point according to the QoS mapping scheme, causing a perceived QoS of the data flow to be monitored, and,
in an instance in which the perceived QoS does not satisfy a predetermined desired QoS threshold:
cause a remedial action to be performed.

52. The computer program product of claim 51, wherein the mapping scheme comprises a mapping scheme in accordance with Table 3.

53. The computer program product of claim 51, wherein the apparatus is directed to determine whether the offload from the first network to the second network should be performed further based at least in part on a QoS measurement resulting from causing dummy packets with traffic characteristics that are the same as the data flow to be transmitted to the second access point, the apparatus being further directed to cause the QoS of the transmitted dummy packets to be measured.
